(19) United States
(12) Patent Application Publication
(10) Pub. No.: US 2014/0320905 A1
(43) Pub. Date: Oct. 30, 2014

(54) DATA MANAGING SYSTEM, IMAGE PROCESSING APPARATUS, IMAGE RESTORING APPARATUS, STORAGE MEDIUM, AND DATA MANAGING METHOD

(71) Applicant: KYOCERA DOCUMENTS SOLUTIONS, INC., Osaka (JP)

(72) Inventor: Shinichi KAWAGUCHI, Osaka (JP)

(73) Assignee: KYOCERA DOCUMENTS SOLUTIONS, INC., Osaka (JP)

(21) Appl. No.: 14/254,916

(22) Filed: Apr. 17, 2014

(30) Foreign Application Priority Data
Apr. 24, 2013 (JP) 2013-091565

(51) Int. Cl. G06F 3/12

(52) U.S. Cl. CPC G06F 3/128; G06F 3/1238; G06F 3/1222
USPC 358/1.15

(57) ABSTRACT

A controlling section of an image processing apparatus performs a data conversion process on image data according to a type that is set with the image processing apparatus, stores obtained converted data as well as address information of the image processing apparatus in the predetermined network into a storage medium, and transmits, when requested by an image restoring apparatus, identifying information used for identifying a reverse conversion method to the image restoring apparatus. A controlling section of the image restoring apparatus reads the address information from the storage medium, obtains the identifying information from the image processing apparatus corresponding to the address information, identifies the identified reverse conversion method on the basis of the identifying information, and restores the image data by performing a reverse conversion process on the converted data by implementing the identified reverse conversion method.

### INCORPORATION BY REFERENCE

The present application claims priority under 35 U.S.C. §119 to Japanese Patent Application No. 2013-091565, filed Apr. 24, 2013. The contents of this application are incorporated herein by reference in their entirety.

### BACKGROUND

The present disclosure relates to a data managing system, an image processing apparatus, an image restoring apparatus, a storage medium, and a data managing method.

For example, an image processing apparatus that encrypts data before storing the data into a USB memory in order to prevent leakage of confidential information has been proposed. In one example of this type of image processing apparatus, when data is to be written into a USB memory, the encryption type is changed depending on whether or not the writing subject (i.e., the user) or the USB memory is a subject/memory that is authenticated in advance.

Further, a security enhanced system as described below has also been proposed. In one example of this type of system, when writing data into a USB memory, an information processing apparatus encrypts the data and stores the encrypted data into the USB memory. After that, when an information processing apparatus is to read the data from the USB memory, it is judged whether or not the information processing apparatus requesting the reading of the data is the information processing apparatus that wrote the data into the USB memory. If it is determined that the requesting information processing apparatus is not the information processing apparatus that wrote the data, the data will not be decrypted. Thus, the data is stored in the information processing apparatus while remaining encrypted.

### SUMMARY

A data managing system according to the present disclosure includes an image processing apparatus and an image restoring apparatus that are connected together via a predetermined network so as to be able to communicate with each other. The image processing apparatus includes a controlling section configured to perform a data conversion process on image data according to a type that is set with the image processing apparatus, to store converted data resulting from the data conversion process as well as address information of the image processing apparatus in the network into a storage medium, and to transmit, when requested by the image restoring apparatus, identifying information used for identifying a reverse conversion method for the data conversion process to the image restoring apparatus. Further, the image restoring apparatus includes a controlling section configured to read the address information from the storage medium, to obtain the identifying information from the image processing apparatus by making the request to the image processing apparatus corresponding to the address information, to identify the reverse conversion method on a basis of the obtained identifying information, and to restore the image data by performing a reverse conversion process on the converted data stored in the storage medium by implementing the identified reverse conversion method.

An image processing apparatus according to the present disclosure includes a controlling section configured to perform a data conversion process on image data according to a type that is set with the image processing apparatus, to store converted data resulting from the data conversion process as well as address information of the image processing apparatus in a predetermined network into a storage medium, and to transmit, when requested by an image restoring apparatus configured to perform a restoring process on the converted data stored in the storage medium, identifying information used for identifying a reverse conversion method for the data conversion process to the image restoring apparatus.

An image restoring apparatus according to the present disclosure includes a controlling section configured to read address information from a storage medium storing therein converted data resulting from a data conversion process performed on image data according to a type that is set with an image processing apparatus as well as the address information of the image processing apparatus in a predetermined network, to obtain identifying information used for identifying a reverse conversion method for the data conversion process from the image processing apparatus corresponding to the address information by requesting the image processing apparatus to transmit the identifying information, to identify the reverse conversion method on a basis of the obtained identifying information, and to restore the image data by performing a reverse conversion process on the converted data stored in the storage medium by implementing the identified reverse conversion method.

A first storage medium according to the present disclosure is a non-transitory computer-readable storage medium storing therein a program that causes an image processing apparatus to function as a controlling section configured to perform a data conversion process on image data according to a type that is set with the image processing apparatus, to store converted data resulting from the data conversion process as well as address information of the image processing apparatus in a predetermined network into a storage medium, and to transmit, when requested by an image restoring apparatus configured to perform a restoring process on the converted data stored in the storage medium, identifying information used for identifying a reverse conversion method for the data conversion process to the image restoring apparatus.

A second storage medium according to the present disclosure is a non-transitory computer-readable storage medium storing therein a program that causes an image restoring apparatus to function as a controlling section configured to read address information from a storage medium storing therein converted data resulting from a data conversion process performed on image data according to a type that is set with an image processing apparatus as well as the address information of the image processing apparatus in a predetermined network, to obtain identifying information used for identifying a reverse conversion method for the data conversion process from the image processing apparatus corresponding to the address information by requesting the image processing apparatus to transmit the identifying information, to identify the reverse conversion method on a basis of the obtained identifying information, and to restore the image data by performing a reverse conversion process on the converted data stored in the storage medium by implementing the identified reverse conversion method.

A data managing method according to the present disclosure includes:

performing, by an image processing apparatus, of a data conversion process on image data according to a type that is set with the image processing apparatus;

storing, by the image processing apparatus, of converted data resulting from the data conversion process as well as address information of the image processing apparatus in a network, into a storage medium;

reading, by an image restoring apparatus, of the address information from the storage medium; and making a request, by the image restoring apparatus, to the image processing apparatus that corresponds to the address information to transmit identifying information used for identifying a reverse conversion method for the data conversion process;

transmitting, by the image processing apparatus, of the identifying information used for identifying the reverse conversion method for the data conversion process to the image restoring apparatus in response to the request; and

restoring, by the image restoring apparatus, of the image data by performing a reverse conversion process on the converted data stored in the storage medium by implementing the reverse conversion method obtained from the image processing apparatus.

### BRIEF DESCRIPTION OF THE DRAWINGS

FIG. 1 is a drawing that schematically shows a configuration overview of a data managing system according to an embodiment of the present disclosure;

FIG. 2 is a block diagram that shows a configuration, in terms of functions, of an image processing apparatus according to the embodiment of the present disclosure;

FIG. 3 is a block diagram that shows a configuration, in terms of functions, of an image restoring apparatus according to the embodiment of the present disclosure;

FIG. 4 is a drawing that schematically shows a list used for identifying a reverse conversion method in the data managing system according to the embodiment of the present disclosure;

FIG. 5 is a flowchart that shows a process related to storing of image data performed by implementing a data managing method according to the embodiment of the present disclosure;

FIG. 6 is a drawing for explaining the process shown in FIG. 5;

FIG. 7 is a drawing for explaining examples of an encrypting process and a data conversion process that are performed on image data, by implementing the data managing method according to the embodiment of the present disclosure;

FIG. 8 is a flowchart of a process related to restoring of image data performed by implementing the data managing method according to the embodiment of the present disclosure;

FIG. 9 is a drawing for explaining the process shown in FIG. 8;

FIG. 10 is a drawing that shows an example of a group forming process in a data managing system in which a different one of conversion types is set with each of the groups, according to another embodiment of the present disclosure; and

FIG. 11 is a drawing that schematically shows a list used for identifying a reverse conversion method in the data managing system shown in FIG. 10.

### DETAILED DESCRIPTION

The following describes exemplary embodiments of the present disclosure, with reference to the drawings.

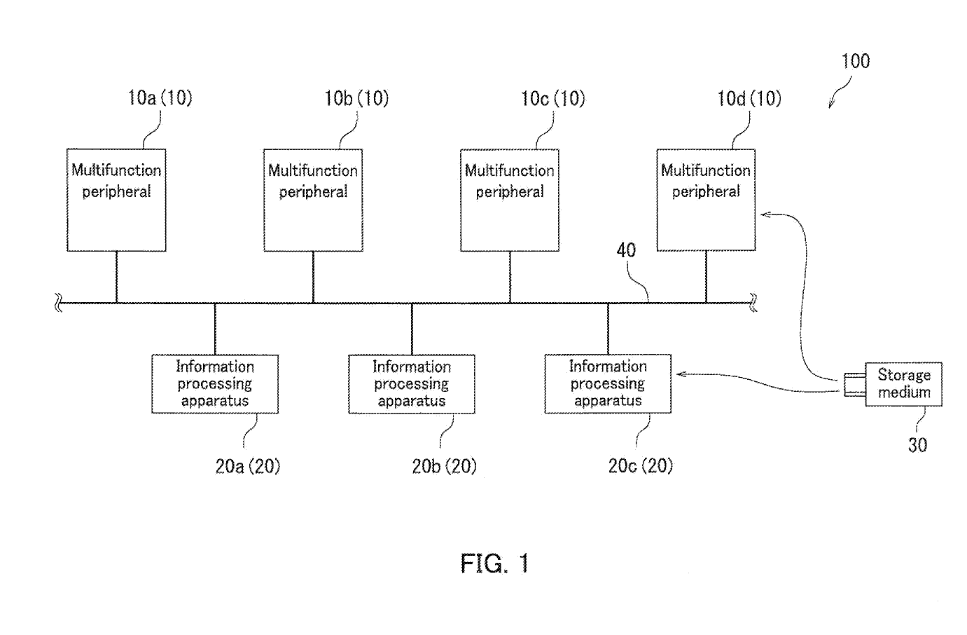

As shown in FIG. 1, a data managing system 100 according to an embodiment includes Multifunction Peripherals (MFPs) 10a, 10b, 10c, and 10d, information processing apparatuses 20a, 20b, and 20c, and a storage medium 30. In the present embodiment, each of the multifunction peripherals 10a to 10d corresponds to an image processing apparatus, whereas each of the information processing apparatuses 20a to 20c corresponds to an image restoring apparatus. In the explanation below, when the multifunction peripherals 10a to 10d do not need to be distinguished from one another (when the characteristics thereof in common are described), each of the multifunction peripherals 10a to 10d will be referred to as a multifunction peripheral 10. Also, when the information processing apparatuses 20a to 20c do not need to be distinguished from one another, each of the information processing apparatuses 20a to 20c will be referred to as an information processing apparatus 20.

The data managing system 100 according to the present embodiment includes the four multifunction peripherals 10 and the three information processing apparatuses 20. However, it is possible to arbitrarily change the number of multifunction peripherals 10 (image processing apparatuses) and the number of information processing apparatuses 20 (image restoring apparatuses) included in the data managing system 100.

In the present embodiment, the multifunction peripherals 10a to 10d and the information processing apparatuses 20a to 20c are connected together via a network 40 so as to be able to communicate with one another. The multifunction peripherals 10 and the information processing apparatuses 20 are able to communicate with one another via the network 40, even when positioned distant from one another. In the present embodiment, because the plurality of information processing apparatuses 20 (the image restoring apparatuses) are connected to every single multifunction peripheral 10 (every single image processing apparatus) via the network 40, each of the multifunction peripherals 10 (the image processing apparatuses) can be used in common among a plurality of users (users of the information processing apparatuses 20). In the present embodiment, the network 40 is a Local Area Network (LAN).

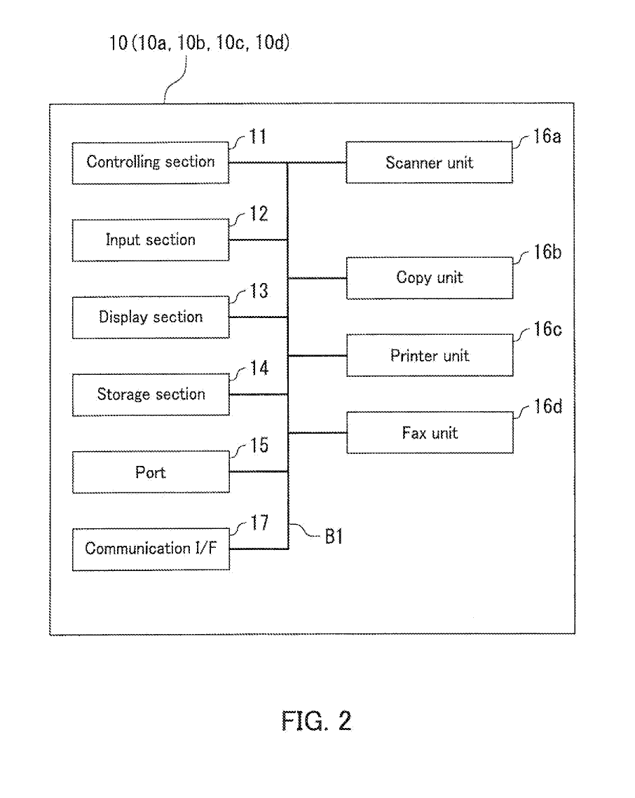

The multifunction peripherals 10 are digital multifunction peripherals, for example. Each of the multifunction peripherals 10 has functions of a scanner, a copier, a printer, and a facsimile (FAX), for example. In the present embodiment, each of the multifunction peripherals 10a to 10d has a configuration shown in FIG. 2, for example.

More specifically, as shown in FIG. 2, each of the multifunction peripherals 10 includes a controlling section 11, an input section 12, a display section 13, a storage section 14, a port 15, a scanner unit 16a, a copy unit 16b, a printer unit 16c, a fax unit 16d, and a communication interface (I/F) 17. These functional elements are connected together via a bus B1 so as to be able to communicate with one another.

The controlling section 11 includes a Central Processing Unit (CPU), a Read Only Memory (ROM), and a Random Access Memory (RAM). The ROM is a Programmable ROM (PROM) such as a flash memory, for example. The RAM is a Dynamic RAM (DRAM), for example. The ROM stores therein computer programs (hereinafter, “programs”) such as a Basic Input/Output System (BIOS), an Operating System (OS), various types of drivers, and various types of application programs, for example. The input section 12 is configured by using a touch panel or operation keys, for example. The display section 13 is configured by using a display device such as a Liquid Crystal Display (LCD) or an Electro Luminescence Display (ELD), for example. When the input section 12 and the display section 13 are configured as a touch panel, it means that the input section 12 and the display section 13 are integrally structured. The storage section 14 is configured by using a non-volatile memory such as a hard disk, for example. The storage section 14 stores therein printing-purpose data, image data read by the scanner unit 16a, data received by the fax unit 16d, and the like. The port 15 is a Universal Serial Bus (USB) port, for example. The scanner unit 16a is a device that reads an image and forms image data corresponding to the read image. The scanner unit 16a corresponds to an image reading section. The multifunction peripherals 10 are connected to the network 40 via the communication I/F 17.

In the present embodiment, each of the multifunction peripherals 10 (e.g., the controlling section 11 or the storage section 14) stores therein address information thereof in the network 40. Without the address information, the information processing apparatuses 20 are not able to access the multifunction peripherals 10. The addresses of the multifunction peripherals 10 in the network 40 may be assigned dynamically (e.g., the address may be changed every time a connection is established) or may be assigned in a fixed manner. In the present embodiment, an Internet Protocol (IP) address is used as the address information of each of the multifunction peripherals 10.

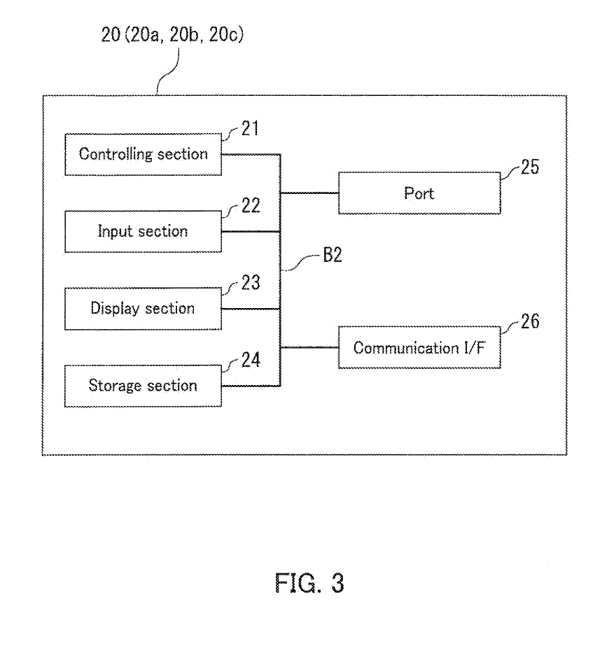

In the present embodiment, each of the information processing apparatuses 20 is configured by using a general-purpose computer (a so-called personal computer), for example. Each of the information processing apparatuses 20a to 20c has a configuration shown in FIG. 3, for example.

More specifically, as shown in FIG. 3, each of the information processing apparatuses 20 includes a controlling section 21, an input section 22, a display section 23, a storage section 24, a port 25, and a communication interface (I/F) 26. These functional elements are connected together via a bus B2 so as to be able to communicate with one another.

The controlling section 21 includes a CPU, a ROM, and a RAM. The input section 22 is configured by using a mouse, a keyboard, or a touch panel, for example. The display section 23 is configured by using a display device such as a Cathode Ray Tube (CRT) or an LCD, for example. When the input section 22 and the display section 23 are configured as a touch panel, it means that the input section 22 and the display section 23 are integrally structured. The storage section 24 is configured by using a non-volatile memory such as a hard disk, for example. The port 25 is a USB port, for example. The information processing apparatuses 20 are connected to the network 40 via the communication I/F 26.

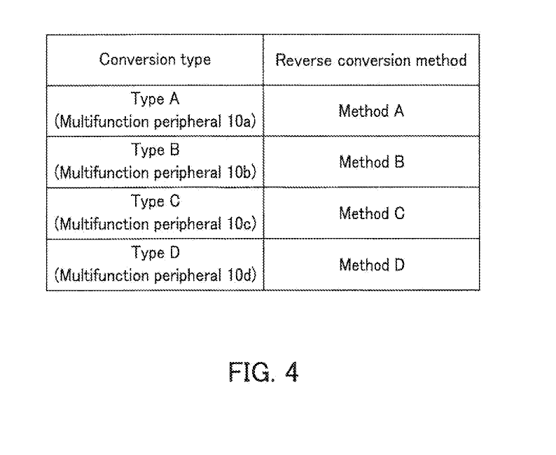

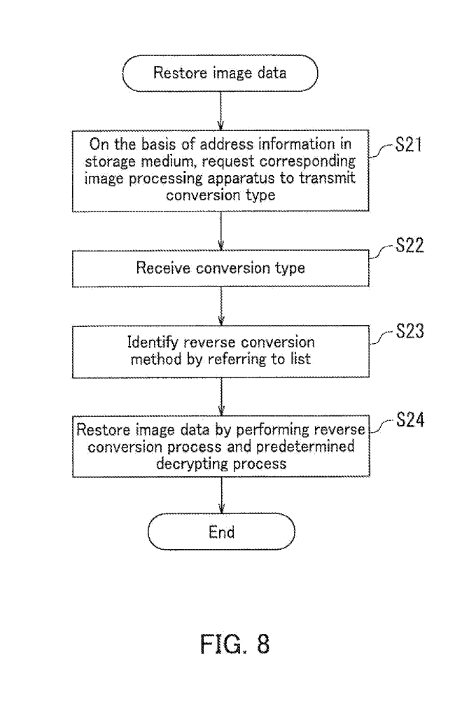

In the present embodiment, the storage section 24 stores therein a list such as that shown in FIG. 4. In the present embodiment, a data-restoring-purpose tool (a program) is prepared in the storage section 24, so that the list is registered in the tool. The list shown in FIG. 4 is electronic data in which conversion types and reverse conversion methods thereof are kept in correspondence with one another. For example, the list shown in FIG. 4 is used for identifying, on the basis of a conversion type (one of types A, B, C, and D) received from any of the multifunction peripherals 10, a reverse conversion method (one of methods A, B, C, and D) that corresponds to the received conversion type (see step S23 in FIG. 8 explained below). In the present embodiment, the controlling section 21 includes programs (or an electronic circuit) used for performing a reverse conversion process of each of the four conversion types (types A, B, C, and D). Further, the controlling section 21 is able to arbitrarily select and execute any of the programs.

The storage medium 30 is a USB memory, for example. The USB memory is a small portable memory. Each of the multifunction peripherals 10 and the information processing apparatuses 20 has the port (the port 15 or 25) that is compliant with the storage medium 30. Thus, the storage medium 30 can be attached to and detached from any of the multifunction peripherals 10 and the information processing apparatuses 20 and can be used (i.e., data can be written thereto and read therefrom) while being connected to any of the multifunction peripherals 10 and the information processing apparatuses 20. The storage medium 30 may be configured by using an SD memory card, a flexible disk, a Compact Disk Read-Only Memory (CD-ROM), a Digital Versatile Disk (DVD), a Magneto-Optical (MO) disk, or any other small portable memory.

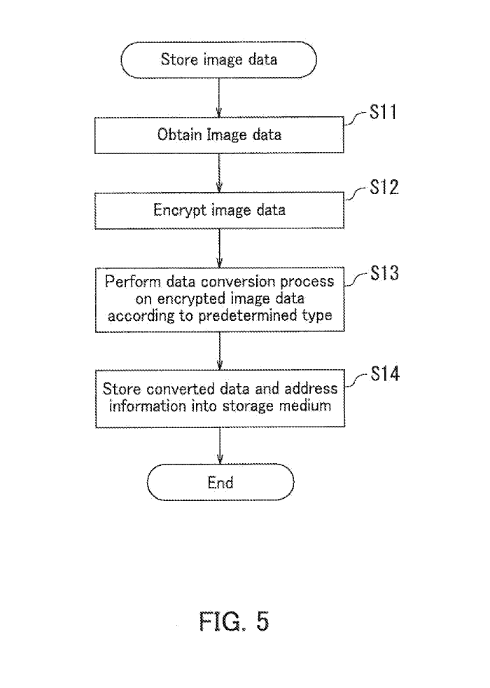

Next, an operation of the data managing system 100 will be explained, with reference to FIGS. 5 to 9. In the following paragraphs, a data managing method implemented by the data managing system 100 will be explained while using an example in which the multifunction peripheral 10c performs an encrypting process and a data conversion process on image data before storing the image data into the storage medium 30, whereas the information processing apparatus 20b restores the image data from the data (converted data) resulting from the encrypting process and the data conversion process.

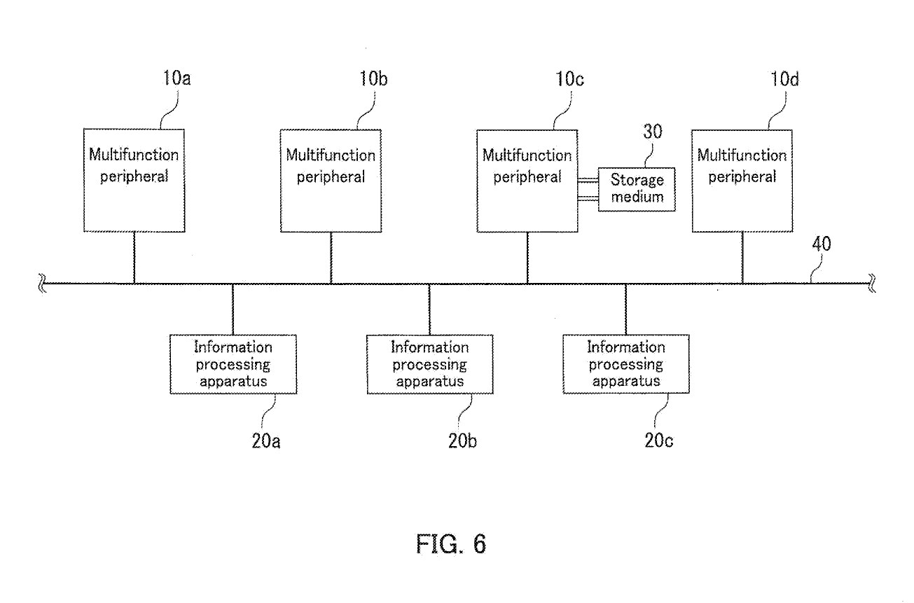

FIG. 5 is a flowchart that shows a process related to the storing of the image data. The process shown in FIG. 5 is performed when, for example, a user has attached the storage medium 30 to the port 15 of the multifunction peripheral 10c (see FIG. 6) and has instructed the multifunction peripheral 10c to obtain the image data and to store the obtained image data into the storage medium 30 (in the present embodiment, when the scanner unit 16a has performed a scan, while the storage medium 30 is specified as a data transfer destination). Further, the process at steps S12 to S14 in FIG. 5 is performed by the controlling section 11 of the multifunction peripheral 10c. More specifically, the CPU executes a program stored in the ROM or the like.

At step S11 in FIG. 5, the image data is obtained. In the present embodiment, on the basis of an operation performed by the user, the scanner unit 16a of the multifunction peripheral 10c performs a scan so as to read an image from an original document (e.g., a written document) and forms image data corresponding to the read image.

Subsequently, at step S12 in FIG. 5, the controlling section 11 of the multifunction peripheral 10c performs the predetermined encrypting process on the image data obtained at step S11.

After that, at step S13 in FIG. 5, the controlling section 11 of the multifunction peripheral 10c performs the data conversion process on the data encrypted at step S12 (hereinafter, “encrypted data”), according to the type that is set with the image processing apparatus (the multifunction peripheral 10c). In the present embodiment, a different one of the conversion types is set with each of the multifunction peripherals 10 (see FIG. 4). In other words, each of the conversion types is unique to a different one of the multifunction peripherals 10. Even the users are unable to find out the conversion types.

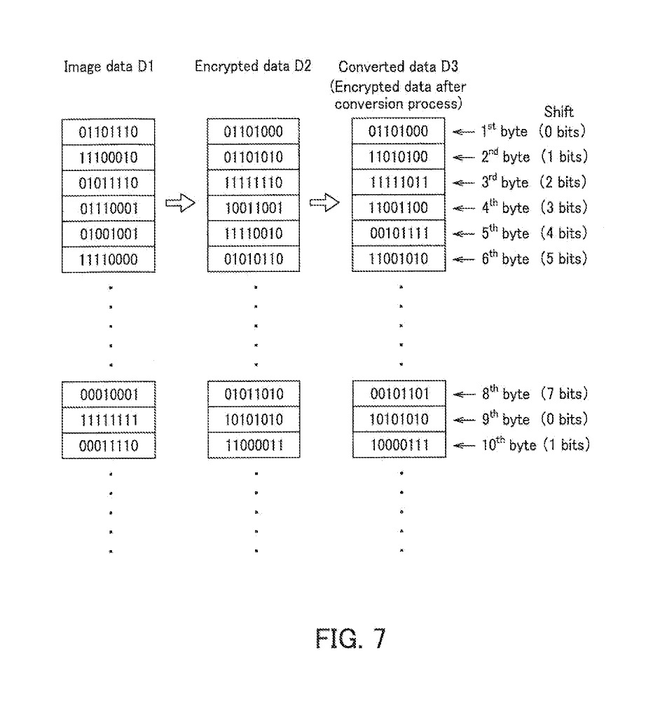

FIG. 7 shows examples of the encrypting process and the data conversion process that are performed on the image data, by implementing the data managing method according to the present embodiment. In FIG. 7, as image data D1, encrypted data D2, and converted data D3, pieces of numerical value data are shown byte by byte.

As shown in FIG. 7, when an encrypting process is performed on the image data D1, the encrypted data D2 is obtained. When a data conversion process is further performed on the encrypted data D2, the converted data D3 is obtained. The encryption type is one that uses the Advanced Encryption Standard (AES), for example. The data conversion process is performed in the following manner, for example.

In the example shown in FIG. 7, to each byte whose remainder of the division by eight is 1, 2, 3, 4, 5, 6, 7, or 0, a corresponding one of 0-, 1-, 2-, 3-, 4-, 5-, 6-, and 7-bit shifts is applied, respectively. In other words, the data conversion process is performed on the 1st byte with a 0-bit shift, on the 2nd byte with a 1-bit shift, on the 3rd byte with a 2-bit shift, on the 4th byte with a 3-bit shift, on the 5th byte with a 4-bit shift, on the 6th byte with a 5-bit shift, on the 7th byte with a 6-bit shift, on the 8th byte with a 7-bit shift, on the 9th byte with a 0-bit shift, and on the 10th byte with a 1-bit shift. However, the present disclosure is not limited to this example. In another example, the data conversion process may be of such a type as follows: to each byte whose remainder of the division by eight is 1, 2, 3, 4, 5, 6, 7, or 0, a corresponding one of 0-, 2-, 4-, 6-, 1-, 3-, 5-, and 7-bit shifts is applied, respectively.

The present disclosure is not limited to the examples described above. The encrypting process and the data conversion process can be of any arbitrary type. Further, in the present embodiment, the encrypting process is performed before the data conversion process. However, alternatively, the data conversion process may be performed before the encrypting process.

Subsequently, at step S14 in FIG. 5, the controlling section 11 of the multifunction peripheral 10c stores the data resulting from the conversion process at step S13 (hereinafter, “converted data”), together with the address information (e.g., the IP address) of the relevant multifunction peripheral (i.e., the multifunction peripheral 10c) in the network 40, into the storage medium 30 (see FIG. 6). In the present embodiment, the converted data and the address information of the multifunction peripheral 10c are stored into the storage medium 30, while being associated with each other. In other words, even if a plurality of pieces of converted data are stored in the single storage medium 30, it is possible to distinguish which piece of address information corresponds to which piece of converted data.

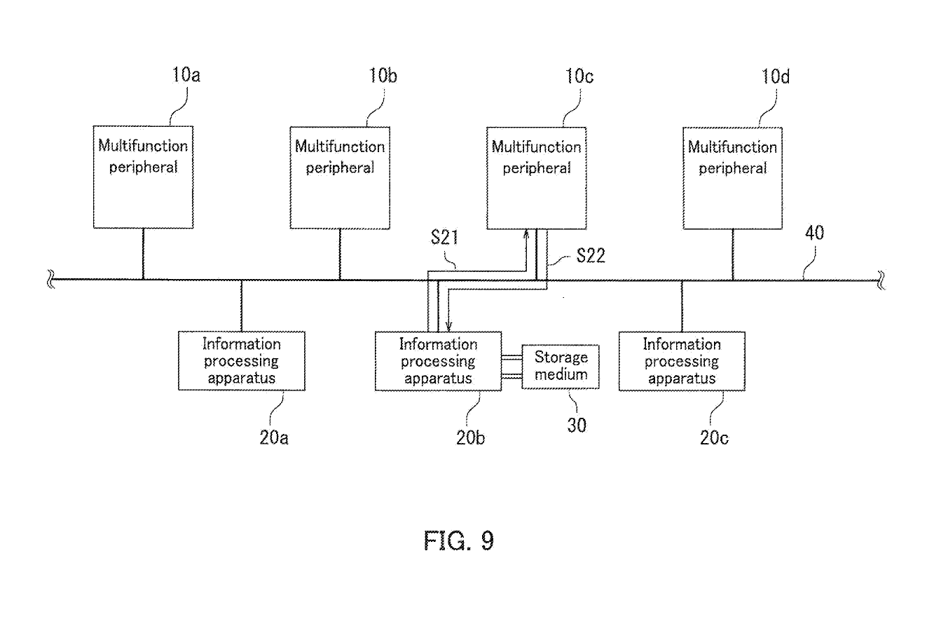

FIG. 8 is a flowchart of a process related to the restoring of the image data. The process shown in FIG. 8 is performed when, for example, a user has attached the storage medium 30 to the port 25 of the information processing apparatus 20b (see FIG. 9) and has instructed the information processing apparatus 20b to read the converted data (the image data) from the storage medium 30. Further, the process at steps S21 to S24 in FIG. 8 is performed by the controlling section 21 of the information processing apparatus 20b. More specifically, the CPU executes a program (e.g., the data-restoring-purpose tool) stored in the ROM, the storage section 24, or the like.

At step S21 in FIG. 8, the controlling section 21 of the information processing apparatus 20b reads the address information (see step S14 in FIG. 5) from the storage medium 30 and requests the multifunction peripheral (the multifunction peripheral 10c) corresponding to the address information to transmit information (hereinafter, “identifying information”) used for identifying a reverse conversion method for the data conversion process (see FIG. 9).

When having received the request (the inquiry about the identifying information) from the information processing apparatus 20b, the multifunction peripheral 10c transmits the identifying information to the information processing apparatus 20b in response to the request. In the present embodiment, the controlling section 11 of the multifunction peripheral 10c transmits the conversion type of the data conversion process as the identifying information. After that, the controlling section 21 of the information processing apparatus 20b receives the identifying information (the conversion type of the data conversion process) at step S22 in FIG. 8 and stores the received identifying information into the storage section 24, for example (see FIG. 9).

At step S23 in FIG. 8, the controlling section 21 of the information processing apparatus 20b identifies the reverse conversion method corresponding to the conversion type of the converted data stored in the storage medium 30, on the basis of the identifying information (the conversion type of the data conversion process) obtained at step S22. In this situation, the controlling section 21 refers to the list (see FIG. 4) stored in the storage section 24 and identifies the reverse conversion method corresponding to the conversion type, on the basis of the conversion type received from the multifunction peripheral 10c. In the present embodiment, the controlling section 21 receives type C shown in FIG. 4 (the reply to the inquiry) at step S22 in FIG. 8 and identifies the reverse conversion method (method C) corresponding to type C at step S23 in FIG. 8, on the basis of the list shown in FIG. 4.

At step S24 in FIG. 8, the controlling section 21 of the information processing apparatus 20b changes the converted data back into the pre-conversion encrypted data, by performing the reverse conversion process on the converted data stored in the storage medium 30, by implementing the reverse conversion method identified at step S23. Further, the controlling section 21 performs a decrypting process corresponding to the encrypting process (see step S12 in FIG. 5) on the converted data. As a result, the image data (see step S11 in FIG. 5) is restored. In the present embodiment, when the decrypting process is to be performed, the user inputs a password via the input section 22. After that, on the basis of an input of a correct password, the controlling section 21 performs the decrypting process corresponding to the encrypting process performed at step S12 in FIG. 5 and restores the original image data (the image data formed by the scanner unit 16a of the multifunction peripheral 10c).

In the present embodiment, the reverse conversion process is performed before the decrypting process. However, alternatively, the decrypting process may be performed before the reverse conversion process.

The data managing system 100 according to the present embodiment includes the multifunction peripherals 10 (the image processing apparatuses) and the information processing apparatuses 20 (the image restoring apparatuses) that are connected together via the network 40 so as to be able to communicate with one another. Each of the multifunction peripherals 10 included in the data managing system 100 includes the controlling section (the controlling section 11 or the like) configured to perform the data conversion process on the image data according to the type that is set with the multifunction peripheral (see step S13 in FIG. 5), to store the converted data resulting from the data conversion process as well as the address information of the multifunction peripheral in the network 40 into the storage medium 30 (see step S14 in FIG. 5), and to transmit, when requested by any of the information processing apparatuses 20 (see step S21 in FIG. 8), the identifying information (e.g., the conversion type of the data conversion process) used for identifying the reverse conversion method for the data conversion process to the information processing apparatus 20. Further, each of the information processing apparatuses 20 included in the data managing system 100 includes the controlling section (the controlling section 21 or the like) configured to read the address information from the storage medium 30, to obtain the identifying information from the multifunction peripheral (see step S22 in FIG. 8) by making the abovementioned request (see step S21 in FIG. 8) to the multifunction peripheral (e.g., the multifunction peripheral 10c) corresponding to the address information, to identify the reverse conversion method on the basis of the obtained identifying information (see step S23 in FIG. 8), and to restore the image data by performing the reverse conversion process (see step S24 in FIG. 8) on the converted data stored in the storage medium 30 by implementing the identified reverse conversion method. In these situations, each of the controlling sections may be realized by the controlling section 11 or the controlling section 21 itself or may be realized by a collaboration between the controlling section 11 or the controlling section 21 and a program, a circuit, or the like provided on the outside thereof.

In the data managing system 100 configured as described above, to read (to restore) the image data stored in the storage medium 30, it is necessary to inquire the multifunction peripheral 10 (the image processing apparatus) about the identifying information (e.g., the conversion type of the data conversion process). For this reason, outsiders are unable to read (restore) the image data stored in the storage medium 30, even if they take away the storage medium 30. Further, because any of the information processing apparatuses 20 (the image restoring apparatuses) in the network 40 is able to inquire the multifunction peripheral 10 (the image processing apparatus) about the identifying information, a certain level of convenience is maintained. As explained here, the data managing system 100 according to the present embodiment makes it possible to reduce the risk of information leakage, while maintaining a high level of convenience.

In the data managing system 100 according to the present embodiment, the identifying information contains the conversion type of the data conversion process. In addition, each of the storage sections 24 stores therein the list (see FIG. 4) indicating the reverse conversion method for each of the conversion types. Further, the controlling section (the controlling section 21 or the like) of each of the information processing apparatuses 20 identifies the reverse conversion method on the basis of the identifying information, by referring to the list (see FIG. 4). In the data managing system 100 configured in this manner, it is possible to easily cause the controlling section of each of the information processing apparatuses 20 to have the abovementioned function (the function to perform the reverse conversion process) with the use of the program or the like. Further, with the configuration described above, each of the multifunction peripherals 10 (the image processing apparatuses) does not need to store therein a means (e.g., a program) for performing the reverse conversion process. Thus, it is possible to easily simplify the configuration of the multifunction peripherals 10 (the image processing apparatuses).

In the data managing system 100 according to the present embodiment, the controlling section (the controlling section 11 or the like) of each of the multifunction peripherals 10 performs the predetermined encrypting process together with the data conversion process on the image data and stores the converted data resulting from the data conversion process and the encrypting process as well as the address information, into the storage medium 30. Further, the controlling section (the controlling section 21 or the like) of each of the information processing apparatuses 20 restores the image data by performing the decrypting process corresponding to the encrypting process and the reverse conversion process on the converted data. In the data managing system 100 configured in this manner, the encrypting process is performed in addition to the abovementioned data conversion process. Thus, the security level related to information leakage is enhanced, and information leakage is therefore less likely to occur.

In the data managing system 100 according to the present embodiment, each of the information processing apparatuses 20 (the image restoring apparatuses) includes the input section 22 used for inputting the password. Further, on the basis of an input of a correct password via the input section 22, the controlling section (the controlling section 21 or the like) of each of the information processing apparatuses 20 performs the decrypting process corresponding to the encrypting process. In the data managing system 100 configured in this manner, by informing only one or more specific users of the password, it is possible to allow only the specific users to read (restore) the image data, or the like.

In the data managing system 100 according to the present embodiment, each of the multifunction peripherals 10 (the image processing apparatuses) includes the scanner unit 16a (the image reading section) configured to read an image and to form image data corresponding to the read image. Further, the controlling section (the controlling section 11 or the like) of each of the multifunction peripherals 10 performs the data conversion process on the image data (the scan data) formed by the scanner unit 16a. In the data managing system 100 configured in this manner, information leakage via the scan data is more likely to occur. Consequently, utilizing the abovementioned technique is especially beneficial.

In the data managing system 100 according to the present embodiment, the abovementioned data conversion process is performed according to the type that is unique to each of the multifunction peripherals 10 (the image processing apparatuses). Thus, because a different one of the conversion types is set with each of the multifunction peripherals 10, the security level related to information leakage is enhanced, and information leakage is therefore less likely to occur.

In the data managing system 100 according to the present embodiment, the storage medium 30 is a small portable memory. When the storage medium 30 is configured as a small portable memory, because the user is able to easily take the data away with him/her, information leakage is more likely to occur. Thus, utilizing the abovementioned technique is especially beneficial.

In the data managing system 100 according to the present embodiment, the information processing apparatuses 20 (the image restoring apparatuses) are connected to the multifunction peripherals 10 (the image processing apparatuses) via the LAN so as to be able to communicate therewith. In the data managing system 100 configured in this manner, to restore the image data (to view the image), it is necessary to use such an information processing apparatus 20 that is connected in the LAN to which the multifunction peripheral that has obtained (e.g., that has scanned) the image data belongs. Thus, with this arrangement, information leakage is less likely to occur.

The present disclosure is not limited to the exemplary embodiments described above. For example, it is possible to carry out the present disclosure in modification examples described below.

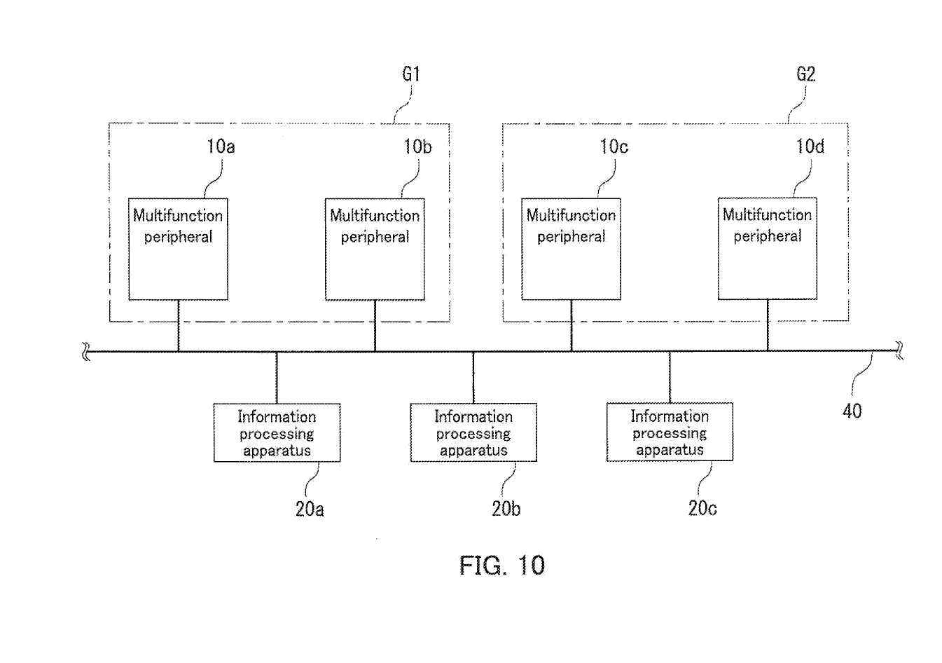

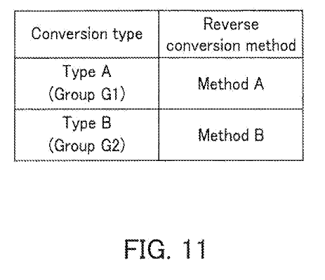

In the exemplary embodiments described above, a different one of the conversion types is set with each of the multifunction peripherals 10 (see FIG. 4). However, the present disclosure is not limited to this example. For instance, as shown in FIG. 10, it is also acceptable to organize a plurality of multifunction peripherals 10 into groups, so that a different one of conversion types is set with each of the groups. In the example shown in FIG. 10, the multifunction peripherals 10a and 10b are organized into a group G1, whereas the multifunction peripherals 10c and 10d are organized into a group G2. The storage section 24 of each of the information processing apparatuses 20 stores therein a list such as that shown in FIG. 11, for example. In the present example, the group G1 (the multifunction peripherals 10a and 10b) performs a data conversion process according to type A, whereas the group G2 (the multifunction peripherals 10c and 10d) performs a data conversion process according to type B. In this configuration, by altering the number of multifunction peripherals 10 (image processing apparatuses) belonging to each group, it is possible to adjust the security level related to information leakage and the level of convenience.

In the exemplary embodiments described above, the multifunction peripheral 10 (the image processing apparatus) transmits the conversion type of the data conversion process to the information processing apparatus 20 (the image restoring apparatus), as the identifying information. However, the present disclosure is not limited to this example, and the identifying information may arbitrarily be arranged. For example, another arrangement is acceptable in which the multifunction peripheral 10 stores therein the list shown in FIG. 4 and transmits a reverse conversion method (the name of the method or the like) corresponding to the conversion type to the information processing apparatus 20, as the identifying information. In the data managing system configured in this manner, the information processing apparatus 20 does not need to store therein the list shown in FIG. 4. Further, yet another arrangement is also acceptable in which the multifunction peripheral 10 transmits a means itself (the program or the like) for performing the reverse conversion process to the information processing apparatus 20, as the identifying information. In the data managing system configured in this manner, the information processing apparatus 20 does not need to store therein the means (the program or the like) for performing the reverse conversion process.

The image data managed in the data managing system (the image data on which the data conversion process and the like are performed) does not necessarily have to be image data (scan data) formed by the scanner unit 16a and may arbitrarily be arranged. The original image data (see step S11 in FIG. 5) may be image data received by the fax unit 16d, or the like.

All of the image processing apparatuses (e.g., the multifunction peripherals) and the image restoring apparatuses (e.g., the computers) included in the data managing system do not necessarily have to be configured as described above. As long as at least one of the image processing apparatuses and at least one of the image restoring apparatuses are configured as described above, it is possible to reduce the risk of information leakage, while maintaining a high level of convenience.

Each of the image processing apparatuses does not necessarily have to be a multifunction peripheral and may arbitrarily be arranged. For example, each of the image processing apparatuses may be a stand-alone unit such as scanner, a copier, a printer, or a facsimile.

Each of the image restoring apparatuses does not necessarily have to be a general-purpose computer and may arbitrarily be arranged. For example, each of the image restoring apparatuses may be a portable device such as a portable phone or may be a device exclusively used for restoring images.

The storage medium 30 does not necessarily have to be a small portable memory and may arbitrarily be arranged. For example, the storage medium 30 may be a stationary external hard disk that is difficult to carry around.

The triggers for performing the processes shown in FIGS. 5 and 8 may arbitrarily be arranged. It is desirable to set appropriate conditions in accordance with the types and the like of the image processing apparatuses, the image restoring apparatuses, and the storage medium.

The network 40 does not necessarily have to be a LAN and may arbitrarily be arranged. For example, the network 40 may be a Wide Area Network (WAN). However, it is considered that it is easier for a LAN to prevent confidential information leakage than for a WAN.

In the exemplary embodiments described above, it is possible to arbitrarily modify or omit any of the configurations (the constituent elements, the dimension, the materials, the shapes, the positional arrangements, and the like) of the data managing system 100, as long as the modifications and/or the omissions do not depart from the gist of the present disclosure.

The functions of the image processing apparatuses and the image restoring apparatuses described in the exemplary embodiments above may be realized by using either hardware (e.g., an electronic circuit) or software (e.g., a program). The program executed by the controlling section 11 or the controlling section 21 in the exemplary embodiments described above may be arranged to be distributable as being stored in a computer-readable recording medium such as a CD-ROM. Further, the program may be stored in a predetermined server in a communication network, so that a client is able to execute or download the program. Furthermore, if specific one or more of the functions are realized by a collaboration between an Operating System (OS) and an application program, only the portion other than the OS may be arranged to be distributable or the like.

The data managing method described in the exemplary embodiments above is not limited to the order and the contents shown in the flowchart in FIG. 5 or FIG. 8. The order and the contents thereof may arbitrarily be modified, as long as the modifications do not depart from the gist of the present disclosure. Further, unnecessary steps may be omitted in accordance with certain purposes or the like. The encrypting process and the corresponding decrypting process (see step S12 in FIG. 5 and step S24 in FIG. 8) may be omitted if unnecessary.

It is possible to arbitrarily combine any of the exemplary embodiments, the modification examples, and the like. It is desirable that an appropriate combination be selected in accordance with certain purposes or the like.

What is claimed is:

1. A data managing system comprising an image processing apparatus and an image restoring apparatus that are connected together via a predetermined network so as to be able to communicate with each other, wherein
the image processing apparatus includes:
a controlling section configured to perform a data conversion process on image data according to a type that is set with the image processing apparatus, to store converted data resulting from the data conversion process as well as address information of the image processing apparatus in the network into a storage medium, and to transmit, when requested by the image restoring apparatus, identifying information used for identifying a reverse conversion method for the data conversion process to the image restoring apparatus, wherein
the image restoring apparatus includes:
a controlling section configured to read the address information from the storage medium, to obtain the identifying information from the image processing apparatus by making the request to the image processing apparatus corresponding to the address information, to identify the reverse conversion method on a basis of the obtained identifying information, and to restore the image data by performing a reverse conversion process on the converted data stored in the storage medium by implementing the identified reverse conversion method.

2. A data managing system according to claim 1, wherein
the identifying information contains a conversion type of the data conversion process, and
the controlling section of the image restoring apparatus identifies the reverse conversion method on the basis of the obtained identifying information by referring to a list indicating a reverse conversion method for each conversion type.

3. A data managing system according to claim 1, wherein
the controlling section of the image processing apparatus performs a predetermined encrypting process together with the data conversion process on the image data and stores the converted data resulting from the data conversion process and the encrypting process as well as the address information into the storage medium, and
the controlling section of the image restoring apparatus restores the image data by performing a decrypting process corresponding to the encrypting process and the reverse conversion process on the converted data.

4. A data managing system according to claim 3, wherein
the image restoring apparatus further includes an input section used for inputting a password, and
the controlling section of the image restoring apparatus performs the decrypting process corresponding to the encrypting process, on a basis of an input of a correct password via the input section.

5. A data managing system according to claim 1, wherein
the image processing apparatus further includes an image reading section configured to read an image and to form image data corresponding to the read image, and
the controlling section of the image processing apparatus performs the data conversion process on the image data formed by the image reading section.

6. A data managing system according to claim 1, wherein
the type set with the image processing apparatus is a type unique to each image processing apparatus.

7. A data managing system according to claim 1, wherein
the storage medium is a small portable memory.

8. A data managing system according to claim 1, wherein
the network is a Local Area Network (LAN).

9. An image processing apparatus comprising:
a controlling section configured to perform a data conversion process on image data according to a type that is set with the image processing apparatus, to store converted data resulting from the data conversion process as well as address information of the image processing apparatus in a predetermined network into a storage medium, and to transmit, when requested by an image restoring apparatus configured to perform a restoring process on the converted data stored in the storage medium, identifying information used for identifying a reverse conversion method for the data conversion process to the image restoring apparatus.

10. An image restoring apparatus comprising:
a controlling section configured to read address information from a storage medium storing therein converted data resulting from a data conversion process performed on image data according to a type that is set with an image processing apparatus as well as the address information of the image processing apparatus in a predetermined network, to obtain identifying information used for identifying a reverse conversion method for the data conversion process from the image processing apparatus corresponding to the address information by requesting the image processing apparatus to transmit the identifying information, to identify the reverse conversion method on a basis of the obtained identifying information, and to restore the image data by performing a reverse conversion process on the converted data stored in the storage medium by implementing the identified reverse conversion method.

11. A non-transitory computer-readable storage medium storing therein a program that causes an image processing apparatus to function as a controlling section configured to perform a data conversion process on image data according to a type that is set with the image processing apparatus, to store converted data resulting from the data conversion process as well as address information of the image processing apparatus in a predetermined network into a storage medium, and to transmit, when requested by an image restoring apparatus configured to perform a restoring process on the converted data stored in the storage medium, identifying information used for identifying a reverse conversion method for the data conversion process to the image restoring apparatus.

12. A non-transitory computer-readable storage medium storing therein a program that causes an image restoring apparatus to function as a controlling section configured to read address information from a storage medium storing therein converted data resulting from a data conversion process performed on image data according to a type that is set with an image processing apparatus as well as the address information of the image processing apparatus in a predetermined network, to obtain identifying information used for identifying a reverse conversion method for the data conversion process from the image processing apparatus corresponding to the address information by requesting the image processing apparatus to transmit the identifying information, to identify the reverse conversion method on a basis of the obtained identifying information, and to restore the image data by performing a reverse conversion process on the converted data stored in the storage medium by implementing the identified reverse conversion method.

13. A data managing method comprising:
performing, by an image processing apparatus, of a data conversion process on image data according to a type that is set with the image processing apparatus;
storing, by the image processing apparatus, of converted data resulting from the data conversion process as well as address information of the image processing apparatus in a network, into a storage medium;
reading, by an image restoring apparatus, of the address information from the storage medium; and making a request, by the image restoring apparatus, to the image processing apparatus that corresponds to the address information to transmit identifying information used for identifying a reverse conversion method for the data conversion process;
transmitting, by the image processing apparatus, of the identifying information used for identifying the reverse conversion method for the data conversion process to the image restoring apparatus in response to the request; and
restoring, by the image restoring apparatus, of the image data by performing a reverse conversion process on the converted data stored in the storage medium by implementing the reverse conversion method obtained from the image processing apparatus.
